(19) United States
(12) Patent Application Publication
(10) Pub. No.: US 2014/0104866 A1
(43) Pub. Date: Apr. 17, 2014

(54) VEHICLE INTERIOR ILLUMINATION LAMP MOUNTING STRUCTURE

(71) Applicants: Akira Maeda, Makinohara-shi (JP); Norihiro Mochiyama, Fujieda-shi (JP)

(72) Inventors: Akira Maeda, Makinohara-shi (JP); Norihiro Mochiyama, Fujieda-shi (JP)

(73) Assignee: YAZAKI CORPORATION, Minato-ku (JP)

(21) Appl. No.: 14/113,899

(22) PCT Filed: Apr. 27, 2012
(86) PCT No.: PCT/JP2012/061802

§ 371 Date: Dec. 5, 2013

(30) Foreign Application Priority Data
Apr. 28, 2011 (JP) 2011-101736

(51) Int. Cl. B60Q 3/02

(52) U.S. Cl. CPC B60Q 3/0203
USPC 362/549

(57) ABSTRACT

A vehicle interior illumination lamp mounting structure includes a roof panel and a bracket. The roof panel is formed with an opening. A first connector is to be mounted on a ceiling. The bracket includes a bracket hook portion to be locked on an edge of the opening. A second connector, to be fitted to the first connector mounted on the ceiling by rotating the bracket, is locked on the bracket. The first connector includes a first wall and a second wall which are configured to receive the second connector therebetween. The first wall is situated far away from the bracket hook portion than the second wall in a state where the bracket is locked on the opening. A length of the first wall is longer than a length of the second wall in a rotating direction of the bracket.

### TECHNICAL FIELD

The present invention is related to a vehicle interior illumination lamp mounting structure for mounting a bracket including a lamp on a roof panel positioned on a rear side of a ceiling of a passenger compartment of a vehicle. The invention is related more particularly to a fitting together structure of a male connector and a female connector.

### BACKGROUND ART

It is known that a bracket including a lamp is mounted in a roof panel positioned on a rear side of a ceiling of a passenger compartment while the bracket is being temporarily fixed (refer to PTL1).

According to the invention described in PTL1, a console case in which a lamp unit is installed is connected to a ceiling wall only at one end of the case by a connecting device. In this temporarily fixed state, a space portion which enables the execution of connection work of connecting a wiring harness to a unit back portion of the lamp unit is secured between the other end of the case and the ceiling wall, whereby the connection work of the wiring harness to the lamp unit can be performed in such a state that the lamp unit is mounted in the console case without supporting the lamp unit by the hand, the wiring harness connection work being thereby facilitated.

By adopting this configuration, the wiring harness can easily be connected to the lamp unit, resulting in an advantage that the mounting work of the lamp unit on the vehicle ceiling wall is improved.

In the vehicle interior illumination lamp bracket described in PTL1, to realize the temporarily fixed state, the number of component parts involved is increased and the structure becomes complex, leading to a problem that the production cost is increased.

### CITATION LIST

### Patent Literature

[PTL1] JP-A-2010-137822

### SUMMARY OF INVENTION

### Technical Problem

It is therefore one advantageous aspect of the present invention to provide a vehicle interior illumination lamp mounting structure which increases the ease with which mounting work of mounting a bracket on a roof panel via a ceiling is performed, obviates a bending step that would be involved in forming the roof panel and eliminates fears that a temporarily locked connector is unlocked by external impact.

### Solution to Problem

According to one advantage of the invention, there is provided a vehicle interior illumination lamp mounting structure comprising:

a roof panel formed with an opening;

a first connector, configured to be mounted on a ceiling;

a bracket including a bracket hook portion configured to be locked on an edge of the opening; and

a second connector, locked on the bracket, and configured to be fitted to the first connector mounted on the ceiling by rotating the bracket,

wherein the first connector includes a first wall and a second wall which are configured to receive the second connector therebetween,

wherein the first wall is situated far away from the bracket hook portion than the second wall in a state where the bracket is locked on the opening, and

wherein a length of the first wall is longer than a length of the second wall in a rotating direction of the bracket.

The first wall may be formed with a guide surface configured to introduce a distal end of the second connector at a distal end of the first wall.

The second wall may be formed with an undercut surface configured to avoid an interference with the second connector at a distal end of the second wall.

The vehicle interior illumination lamp mounting structure may be configured such that: a first terminal is provided in the first connector between the first wall and the second wall; and the first terminal is formed with undercut surfaces on both sides of a distal end of the first terminal, so as to avoid an interference with a second terminal provided in the second connector.

### Advantageous Effects of Invention

According to the invention, when the bracket on which the connector is mounted rotates about a distal end of the bracket hook portion as a fulcrum, an upper surface of the connector is prevented from coming into contact with a distal end of the wall surface, which enables a smooth fitting of the connector into the mating connector. Moreover, the connector can be made smaller in size, and the connector can be guided to a predetermined rigid position by the outer wall.

According to the invention, when the bracket on which the connector is mounted rotates about the distal end of the bracket hook portion as a fulcrum, a distal end which faces the wall surface of the connector is introduced inwards in a smooth fashion by the guide surface, and therefore, the connector on the bracket is enabled to fit into the connector on the ceiling in a smooth fashion.

According to the invention, when the bracket on which the connector is mounted rotates about the distal end of the bracket hook portion as a fulcrum, a halfway portion of the connector is prevented from coming into contact with the mating connector due to the undercut surface, whereby the connector on the bracket can be inserted into the connector on the ceiling with a low insertion force.

According to the invention, when the bracket on which the connector is mounted rotates about the distal end of the bracket hook portion as a fulcrum, the connector on the bracket is prevented from interfering with the connector on the ceiling, whereby not only can both the terminals be prevented from being damaged by each other, but also the connector on the bracket can be inserted into the connector on the ceiling with a low insertion force.

### BRIEF DESCRIPTION OF DRAWINGS

FIG. 1 is an exploded perspective view illustrating a portion of a vehicle interior illumination lamp according to the invention which has a rotational mounting structure.

FIGS. 2A to 2F show drawings illustrating a female connector according to Embodiment 1 of the invention. FIG. 2A is a plan view, FIG. 2B is a front view, FIG. 2C is a perspective view, FIG. 2D is a side view. FIGS. 2E and 2F are exploded perspective views of a female connector housing 21. FIG. 2E is a perspective view of the female connector housing, FIG. 2F is a perspective view of female terminals.

FIGS. 3A and 3B show drawings illustrating a bracket on which the female connector is mounted. FIG. 3A is a perspective view and FIG. 3B is a plan view of a portion where the female connector is mounted.

FIGS. 4A to 4D show drawings illustrating a male connector according to the invention. FIG. 4A is a plan view, FIG. 4B is a front view, FIG. 4C is a perspective view, and FIG. 4D is a side view of the male connector.

FIGS. 5A and 5B shows drawings illustrating an interior of the male connector, of which FIG. 5A is a front view, and FIG. 5B is a sectional view taken along the line A-A and seen in a direction indicated by arrows A in FIG. 5A.

FIGS. 6A and 6B show drawings illustrating a mounting method of mounting the male connector on a ceiling. FIG. 6A is a perspective view, and FIG. 6B is a plan view.

FIGS. 7A to 10B are side sectional views illustrating a mounting procedure of the bracket according to the invention.

FIGS. 7A and 7B show side sectional views illustrating a first step of the mounting procedure. FIG. 7A is an overall view, and FIG. 7B is an enlarged view of the connectors.

FIGS. 8A and 8B show side sectional views illustrating a second step of the mounting procedure. FIG. 8A is an overall view, and FIG. 8B is an enlarged view of the connectors.

FIGS. 9A and 9B show side sectional views illustrating a third step of the mounting procedure. FIG. 9A is an overall view, and FIG. 9B is an enlarged view of the connectors.

FIGS. 10A and 10B show side sectional views illustrating a fourth step of the mounting procedure. FIG. 10A is an overall view, and FIG. 10B is an enlarged view of the connectors.

FIG. 11 is an exploded perspective view illustrating a portion of a vehicle interior illumination lamp according to the prior invention which has a rotational mounting structure.

### DESCRIPTION OF EMBODIMENTS

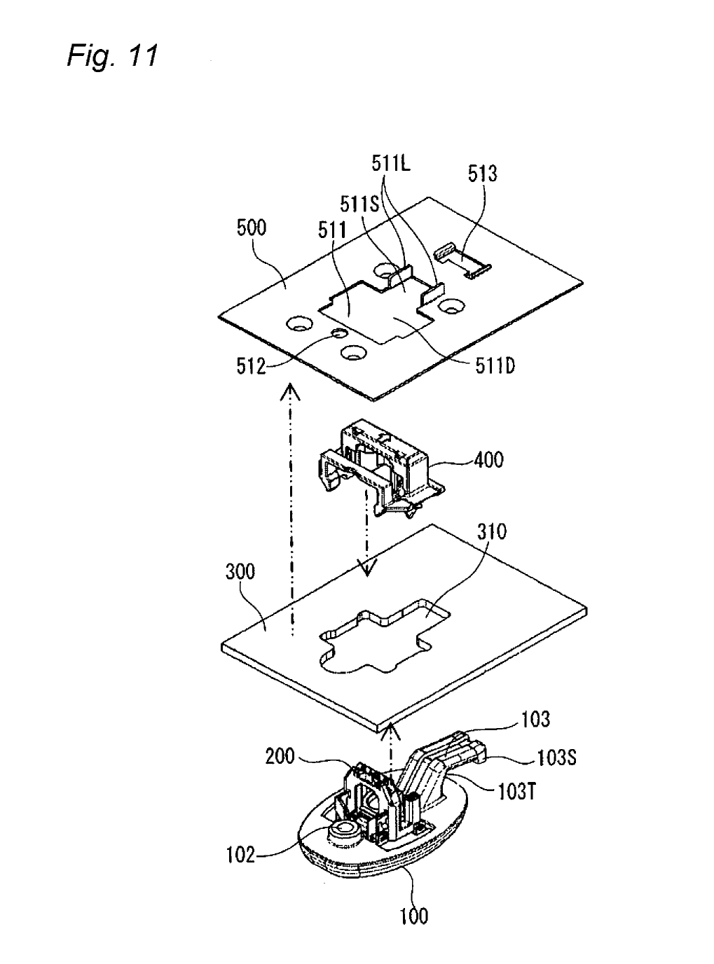

Then, the applicant of this patent application conceived a related art. The related art does not require many component parts, is simple in structure and hence reduces the projection cost. Referring to FIG. 11, the related art will be described below. In the related art shown in FIG. 11, when mounting a bracket 100 on a ceiling 300, the bracket 100 is prevented from deflecting transversely and longitudinally so as to increase the ease of the mounting work, facilitating the fastening of the bracket 100 with a machine screw. Specifically speaking, an opening portion 511 is formed in a roof panel 500. A male connector 400 is brought into engagement with a larger portion 511D so as to be fixed thereto, and guide portions 511L are erected from the roof panel 500 in a smaller portion 511S of the opening portion 511. Additionally, a hole 512 and an engagement hollow space 513 are formed on both sides of the opening portion 511. Then, a female connector 200 is placed on the bracket 100, and a hook portion 103 is provided on the bracket 100 so as to extend thereover. In the mounting work of mounting the bracket 100 on the ceiling 300, transverse deflections of the hook portion 103 are eliminated by the guide portions 511L, so that the female connector 200 and the male connector 400 are fitted together quickly. In addition, by locking of a distal end portion 103S of the hook portion 103 in the engagement hollow space 513 and abutment of an inner surface of an inclined portion 103T with one side surface of the smaller portion 511S, longitudinal deflections of the hook portion 103 are eliminated, whereby the fastening work of fastening the bracket 100 to the roof panel 500 with a machine screw is facilitated.

In the related art, however, the bending work is needed in forming the roof panel, which increases the number of man hours involved and requires a skilled person, leading to a problem of time and cost.

In addition, in case external impact is applied while the female connector is temporarily locked, the temporary locking of the female connector may be unlocked.

Hereinafter, referring to the drawings, a rotational mounting structure of a vehicle interior illumination lamp according to the invention will be described in detail.

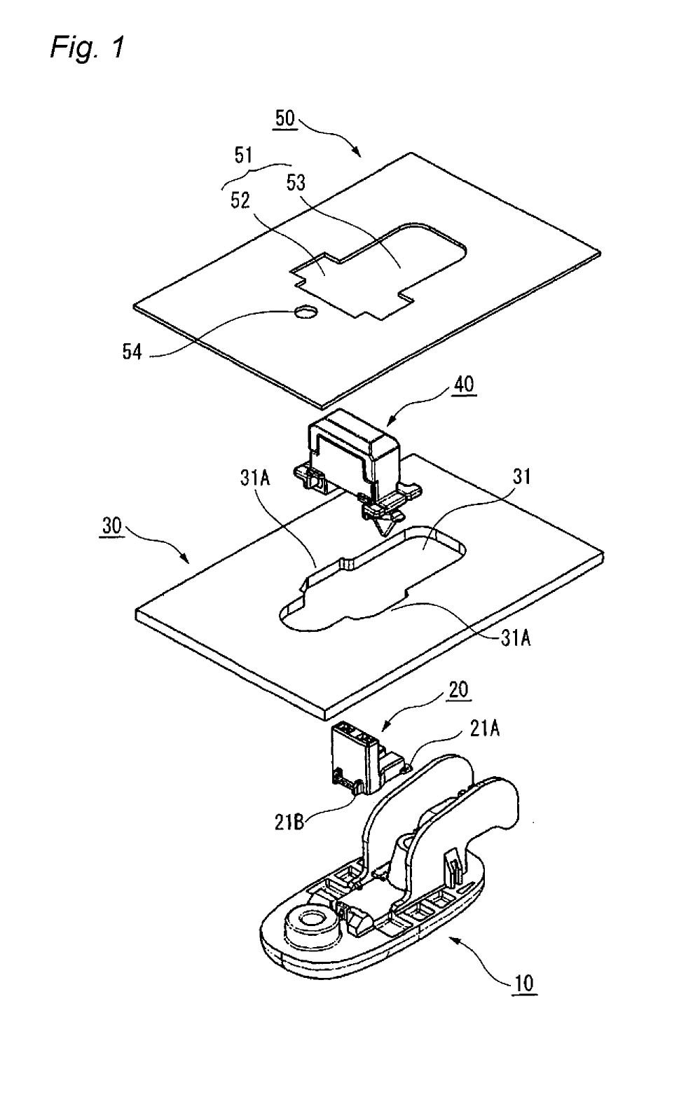

FIG. 1 is an exploded perspective view illustrating a portion of a vehicle interior illumination lamp according to the invention which has a rotational mounting structure. In FIG. 1, a portion of the vehicle interior illumination lamp which has a rotational mounting structure includes, from bottom to top, a bracket (a lamp) 10, a female connector (a second connecter) 20 which is mounted on the bracket 10, a ceiling 30 which defines a passenger compartment of a vehicle, a male connector (a first connector) 40 which is mounted on a rear side of the ceiling 30 and a roof panel 50 which is made up of sheet metal which constitutes a body and which is used to mount the bracket 10 on the ceiling 30.

Hereinafter, the constituent parts of the portion having the rotational mounting structure will be described in the order in which they are itemized above.

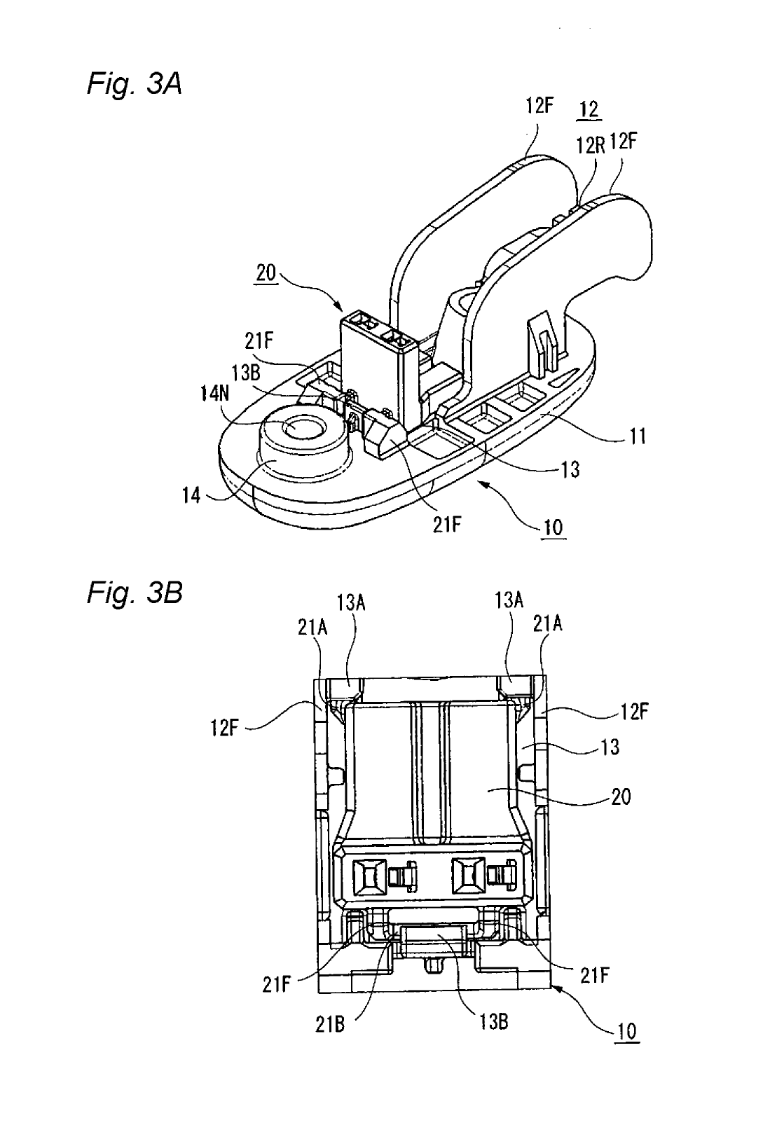

FIGS. 3A and 3B show drawings illustrating the bracket which installs the female connector 20. FIG. 3A is a perspective view of the bracket and FIG. 3B is a plan view of a portion where the female connector is mounted. In FIGS. 3A and 3B, the bracket 10 is formed of a resin and includes a substantially oval bracket base 11, a bracket hook portion 12 which includes, in turn, two hook arm pieces 12F which are erected from the bracket base 11 so as to face each other with a space provided therebetween and which extend horizontally and a distal ends connecting portion 12R which connect together distal ends of the two hook arm pieces 12F, a female connector mounting portion 13 where the female connector 20 is mounted, and a boss 14 which includes a screw hole 14N provided in a center thereof.

Hereinafter, the bracket base 11, the bracket hook portion 12 and the female connector mounting portion 13 will be described.

The bracket base 11 (FIG. 3A) is a substantially oval part formed of a resin and having a lens and a light source (which is invisible in FIGS. 3A and 3B) which are disposed on a front side (a vehicle compartment side) thereof. The bracket hook portion 12 is erected on a rear side of the bracket base 11. The bracket base 11 also includes the female connector mounting portion 13 and the substantially circular boss portion 14 on the rear side thereof.

The bracket hook portion 12 (FIG. 3A) includes the two hook arm pieces 12F which are erected from the bracket base 11 so as to face each other with the space provided therebetween and which extend horizontally above the bracket base 11 and the distal ends connecting portion 12R which connects together the distal ends of both the hook arm pieces 12F. A distal end portion of the bracket hook portion 12 is passed from a T-shaped opening 51 in the roof panel 50 (FIG. 1) to a rear side of the roof panel 50, and the bracket 10 is rotated about a fulcrum lying near the distal end portion on the rear side of the roof panel 50, whereby the bracket 10 can easily be mounted on the ceiling 30.

The female connector mounting portion 13 (FIG. 3A) is a quadrangular area which is defined between a space held by the two hook arm pieces 12F of the bracket hook portion 12 and the boss 14 on the rear surface of the bracket base 11. Then, two locking projection fastening pieces 13A and a locking bar restraint piece 13B are formed on the female connector mounting portion 13 so as to be erected therefrom in a way that will be described below.

The locking projection fastening pieces 13A are provided at both ends of one side (an upper side in FIG. 3B) of the quadrangular area of the female connector mounting portion 13 so as to be erected into a hook-like shape from the bracket base 11.

Locking projections 21A of the female connector 20 are inserted into the corresponding locking projection fastening pieces 13A from open sides thereof, and therefore, the locking projection fastening pieces 13A may not have to be displaced elastically.

The locking bar restraint piece 13B is formed at a center of a side of the quadrangular area of the female connector mounting portion 13 which is opposite to the side where the locking projection fastening pieces 13A are provided (a lower side in FIG. 3B) so as to be erected into a hook-like shape from the bracket base 11. In the locking bar restraint piece 13B, the hook-shaped portion is made to be displaced elastically due to the elasticity of a resin material of which the locking bar restraint piece 13 is made. Additionally, a portion where the hook-shaped portion comes into contact with a locking bar 21B is tapered.

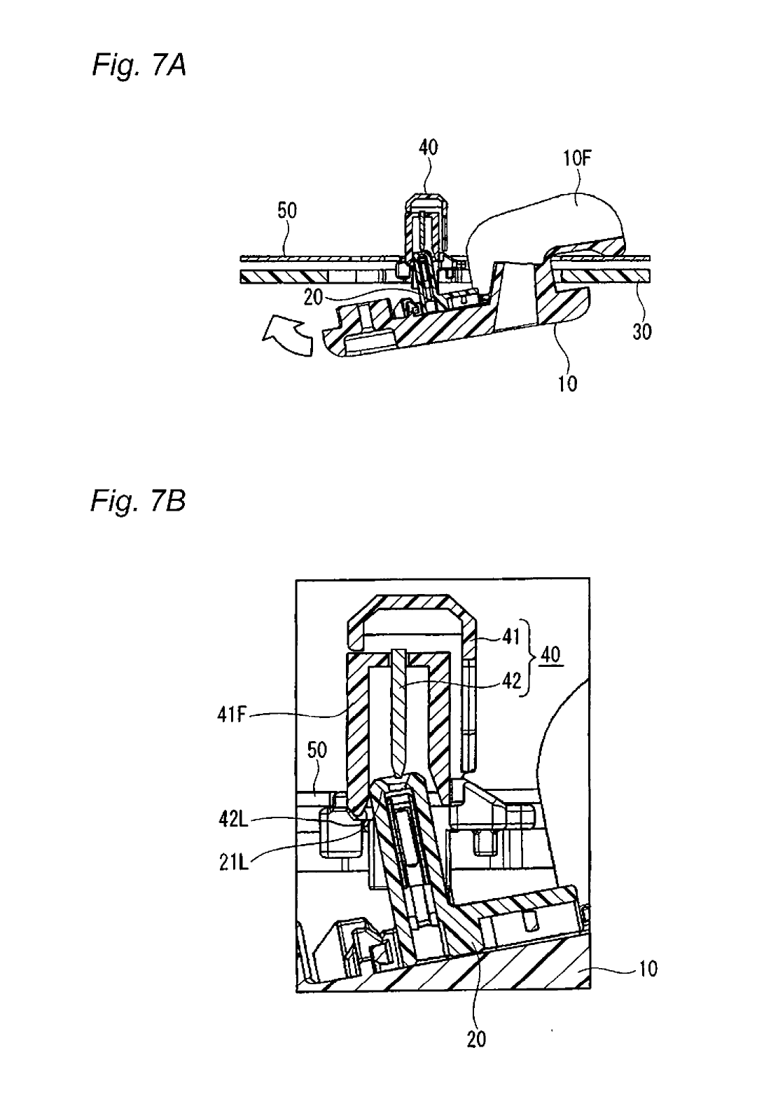

Consequently, when the locking bar 21B (refer to FIG. 7B) is lowered to come into contact with the hook-shaped portion of the locking bar restraint piece 13B, the locking bar 21 presses on the tapered portion of the hook-shaped portion and deforms the hook-shaped portion so that it withdraws. Then, at a point in time when the locking bar 21B passes the tapered portion, the hook-shaped portion is elastically restored to the previous position to restrain the locking bar 21B from moving.

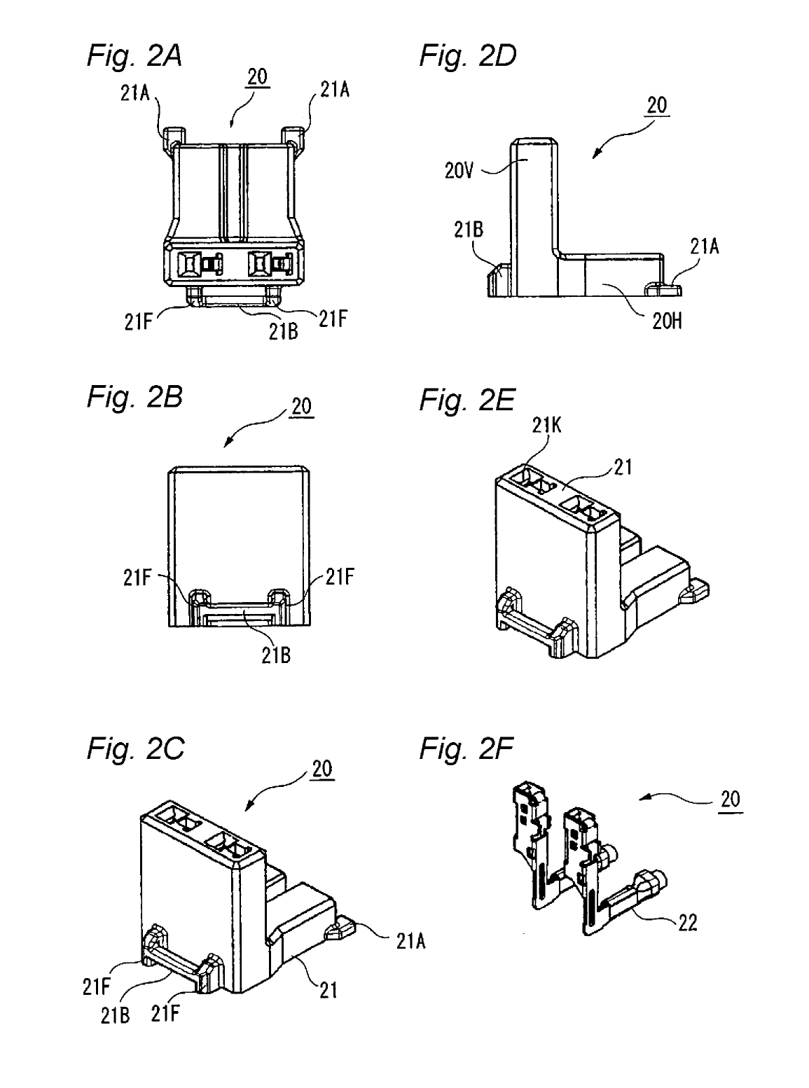

FIGS. 2A to 2F show drawings illustrating the female connector according to the invention. FIG. 2A is a plan view, FIG. 2B is a front view, FIG. 2C is a perspective view, FIG. 2D is a side view. FIGS. 2E and 2F are exploded perspective views of a female connector housing. FIG. 2E is a perspective view of the female connector housing, and FIG. 2F is a perspective view of female terminals.

An external shape of the female connector 20 is defined by a female connector base portion 20H (FIG. 2D) which is placed to be fixed to the female connector mounting portion 13 on the bracket base 11 and a vertical portion 20V (FIG. 2D) which is erected vertically from one side of the female connector base portion 20H and which has openings 21K (FIG. 2E) into which male terminals are inserted in a top portion thereof.

Constituent parts of the female connector 20 include a female connector housing 21 (FIG. 2E) which includes, in turn, female terminal accommodation compartments which accommodate female terminals in interiors thereof and female terminals 22 (FIG. 2F) which are accommodated in the female terminal accommodation compartments in the female connector housing 21.

As shown in FIG. 3B, the locking projections 21A, 21A (FIGS. 2A, 2C, 2D) and the locking bar 21B (FIG. 2A, 2B, 2C) are formed on the female connector base portion 20H of the female connector 20 in a way that will be described below.

The locking projections 21A are formed so as to project forwards and transversely outwards from both sides of a distal end of the female connector base portion 20H. The locking projections 21A are restrained by the locking projection fastening pieces 13A which are erected into the hook shape from the bracket base 11.

The locking bar 21B is formed at a center of a lower portion on a side of the vertical portion 20V of the female connector 20 which lies opposite to a side facing the bracket hook portion while being supported at both ends thereof by two leg portions 21F which are formed so as to be spaced apart from each other. The locking bar 21B is restrained by the locking bar restraint piece 13B which is erected into the hook-shape from the bracket base 11. To mount the female connector 20 on the bracket 10, firstly, the two locking projections 21A are inserted obliquely into spaces defined between hooks of the locking projection fastening pieces 13A on the bracket base 11 and the bracket base 11 from a side facing the spaces, whereby vertical movements of the female connector base portion 20H are restrained, and lateral movements thereof are restrained between both the hook arm pieces 12F, 12F.

Following this, when the female connector 20 is lowered from the locking bar 21B side thereof, the locking bar 21B comes into contact with the locking bar restraint piece 13B on the bracket base 11. The portion of the hook-shaped portion at the top portion of the locking bar restraint piece 13B which comes into contact with the locking bar 21B is tapered, and the locking bar restraint piece 13B can be displaced due to the elastic characteristics of the resilient material of which the locking bar restraint piece 13B is made. Therefore, when the locking bar 21B is lowered further, the hook-shaped portion is gradually displaced to withdraw from its normal position, allowing the locking bar 21 to be so lowered. Then, at the point in time when the locking bar 21B passes the hook-shaped portion, the locking bar restraint piece 13B is elastically restored to its normal condition, whereby the hook-shaped portion is returned to its normal position. Then, the locking bar restraint piece 13 restrains the locking bar 21B, whereafter, unless the locking bar restraint piece 13 is stretched to open, the female connector 20 cannot move upwards.

In this way, the female connector 20 is restrained from moving longitudinally, transversely and vertically in the female connector mounting portion 13, thereby making it possible to eliminate fears that the female connector 20 is disconnected from the bracket base 11 by impact.

Returning to FIG. 1, the ceiling 30 (FIG. 1) is a flat panel material which define the passenger compartment of the vehicle. The bracket 10 is mounted on the ceiling 30 by use of the roof panel 50 which is disposed near the ceiling 30 on a rear side thereof. An opening portion 31 is formed in a central portion of the ceiling 30, and the female connector 20 and a back portion of the bracket 10 are passed through the opening portion 31. The opening portion 31 has a shape made up of a substantially rectangular opening portion and an expanded opening portion which is defined by lateral surfaces 31A, 31A which are formed as a result of facing longer sides of the rectangular opening portion receding partially somewhere along the length thereof. A pair of holding portions 41A, 41A which are formed at a lower end of a male connector 40 so as to extend downwards therefrom are held between the lateral surfaces 31A, 31A.

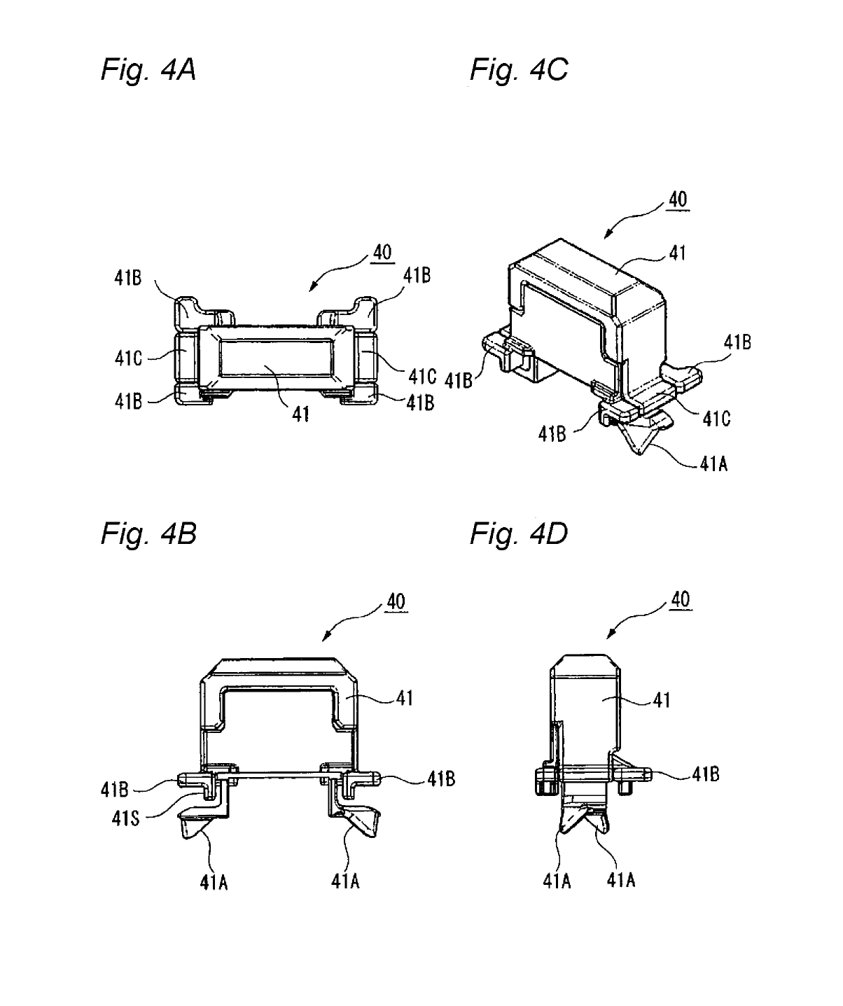

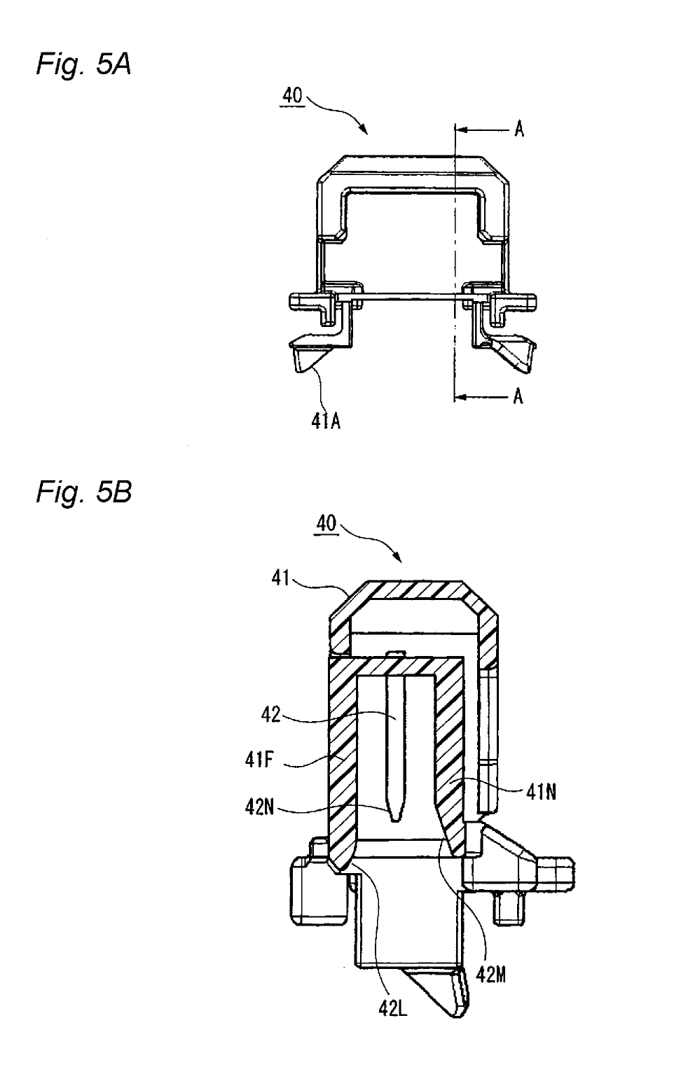

FIGS. 4A to 4D show drawings illustrating a male connector according to the invention. FIG. 4A is a plan view, FIG. 4B is a front view, FIG. 4C is a perspective view, and FIG. 4D is a side view of the male connector. FIGS. 5A and 5B show drawings illustrating an interior of the male connector. FIG. 5A is a front view, and FIG. 5B is a sectional view taken along the line A-A and seen in a direction indicated by arrows A in FIG. 5A.

As is seen from the sectional view in FIG. 5B, the male connector 40 includes a male connector housing 41 which fits in the female connector housing 21 and male terminals 42 which are insert molded within the male connector housing 41 for contact with the corresponding female terminals 22.

An external shape of the male connector housing 41 is made up of a substantially flat rectangular parallelepiped portion which accommodates the female housing 20, fixing portions 41B which are formed elastically at a lower end portion of the rectangular parallelepiped portion so as to face the holding portions 41A, 41A, respectively, and horizontal portions 41C which are also formed at the lower end portion of the rectangular parallelepiped portion.

As is seen from FIG. 4C, the horizontal portions 41C are provided at a lower end of the male connector housing 41 so as to extend horizontally outwards therefrom. Additionally, to ensure the stable fixing of the male connector housing 41, the fixing portions 41B, 41B are provided so as to extend flush with and transversely outwards from both ends of each of the horizontal portions 41C in such a manner as to hold the horizontal portion 41C therebetween.

On the other hand, the holding portions 41A are formed so as to be spaced a distance which is slightly shorter than the thickness of the ceiling 30 (FIG. 1) from a horizontal plane of the fixing portions 41B and the horizontal portion 41C at each end of the male connector housing 41. Thus, the holding portions 41A, the fixing portions 41B and the horizontal portions 41C are brought into engagement with the lateral surfaces 31A, 31A (FIG. 1) of the opening portion 31 in the ceiling 30.

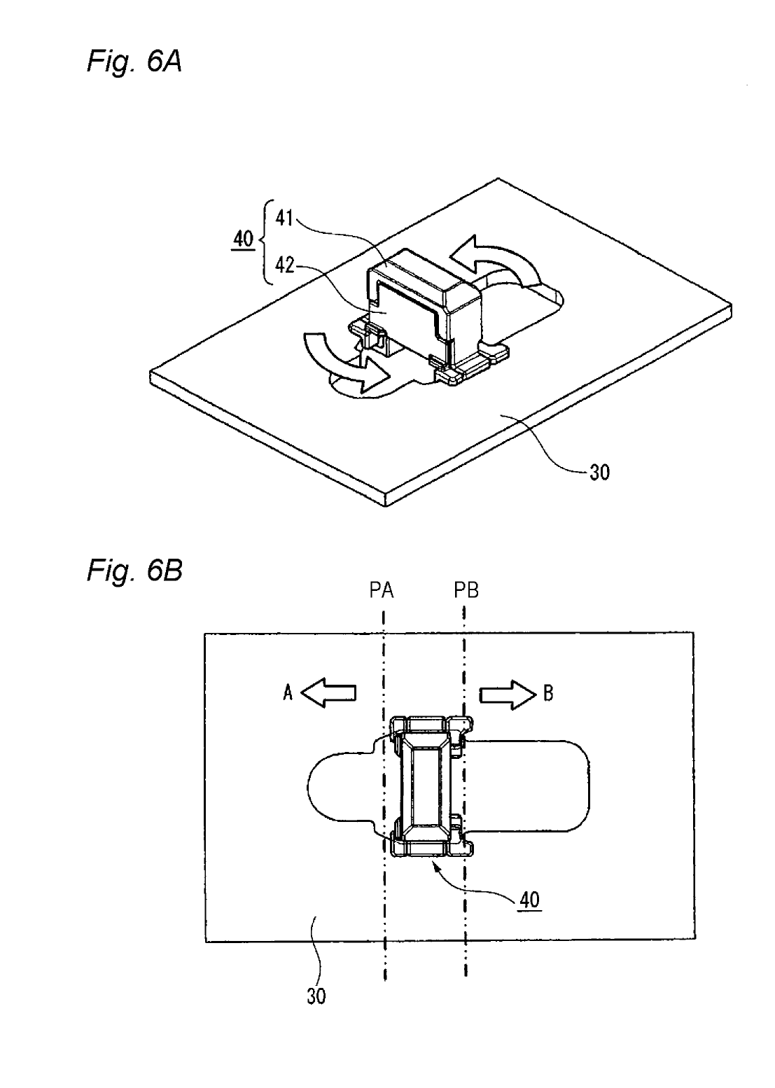

FIGS. 6A and 6B shows drawings illustrating a mounting method of mounting the male connector 40 that is configured as described above on the ceiling 30. FIG. 6A is a perspective view, and FIG. 6B is a plan view. The male connector 40 is lowered from above the ceiling 30 while longer side portions of the male connector 40 are aligned with the direction of the longer sides of the rectangular opening portion 31 in the ceiling 30. When gaps defined between the holding portions 41A and the fixing portions 41B (and the horizontal portion 41C) reach a surface of the ceiling 30, the male connector 40 is stopped from being lowered, and following this, the male connector 40 is rotated in a direction indicated by arrows in FIG. 6A. When the male connector 40 is stopped from being rotated when the holding portions 41A and the fixing portions 41B (and the horizontal portions 41C) of the male connector 40 finally reach the lateral surfaces 31A of the expanded opening portion of the opening portion 31 in the ceiling 30, the male connector 40 is locked on the ceiling 30 in an ensured fashion.

Thereafter, even in the event that the male connector 40 attempts to move towards the front or rear of the ceiling 30 (in vertical directions in FIG. 6B), perpendicularly downwards extending portions 41S (FIG. 4B) of the fixing portions 41B come into abutment with the lateral surfaces 31A of the ceiling 30, whereby the male connector 40 is not allowed to so move. Additionally, even in the event that the male connector 40 attempts to move towards the left or right of the ceiling 30 (horizontal directions in FIG. 6B), since the male connector 40 is in engagement with the expanded opening portion of the opening portion 31, such an attempt of the male connector 40 being restricted by narrow opening portions, the male connector 40 can move neither in a direction A (FIG. 6B) nor in a direction B (FIG. 6B). The male connector 40 is prevented from moving in the direction A at a position PA and in the direction B at a position PB.

FIG. 5B shows, of wall surfaces of the male connector 40, a wall surface 41N (a second wall) which is situated near a rotating side of the bracket 10 and a wall surface 41F (a first wall) which is situated far away from the rotating side of the bracket 10. A length of the wall surface 41F which is situated far away from the rotating side is made longer than a length of the wall surface 41N which is situated near the rotating side as shown in FIG. 5B. By adopting this configuration, when the bracket 10 which installs the female connector 20 is rotated about a distal end of the bracket hook portion 12 as a fulcrum, as shown in FIG. 7B, an upper surface of the female connector 20 is prevented from coming into contact with a distal end of the wall surface 41N due to the length of the wall surface 41N being shorter, whereby the female connector 20 fits in the male connector 40 in a smooth fashion. Additionally, the connector can be made smaller in size, and the connector can be guided to a predetermined rigid position by an outer wall.

A guide surface (a moderately curved surface) 42L for introducing a distal end of the female connector 20 is formed on an inner side (a terminal side) at a distal end of the wall surface 41F which is situated far away from the rotating side as shown in FIG. 5B. By adopting this configuration, when the bracket 10 which installs the female connector 20 is rotated about the distal end of the bracket hook portion 12 as a fulcrum, as shown in FIG. 7B, a distal end 21L of a side of the female connector 20 which faces the wall surface 41F is introduced inwards by the guide surface 42L in a smooth fashion, whereby the female connector 20 smoothly fits in the male connector 40.

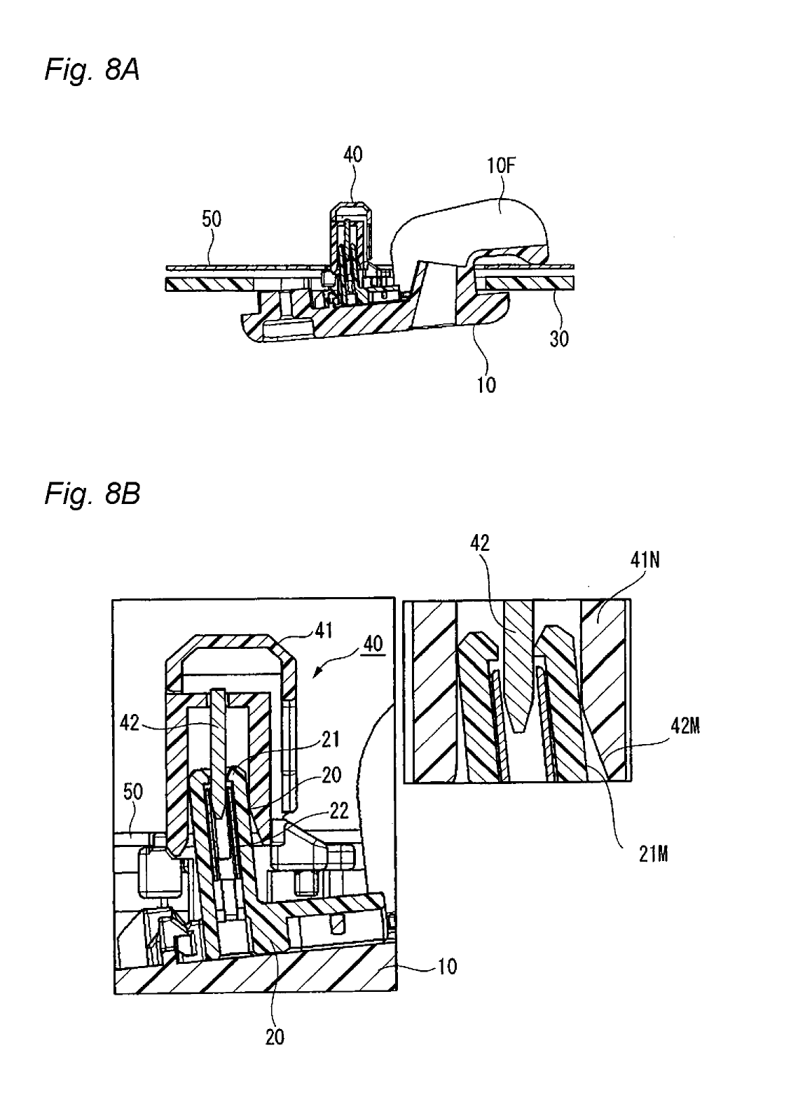

An undercut 42M is formed on an inner side (a terminal side) of the wall surface 41N which is situated near the rotating side as shown in FIG. 5B to avoid the interference of the wall surface 41N of the male connector 40 with a halfway portion 21M of the female connector 20. By adopting this configuration, as shown in FIG. 8B, since the halfway portion 21M of the female connector 20 is prevented from coming into contact with the wall surface 41N of the male connector 40 by the undercut 42M, the female connector 20 can be inserted into the male connector 40 with a low insertion force. Even in case the halfway portion 21M comes into contact with the wall surface 41N, the former slightly contacts the latter.

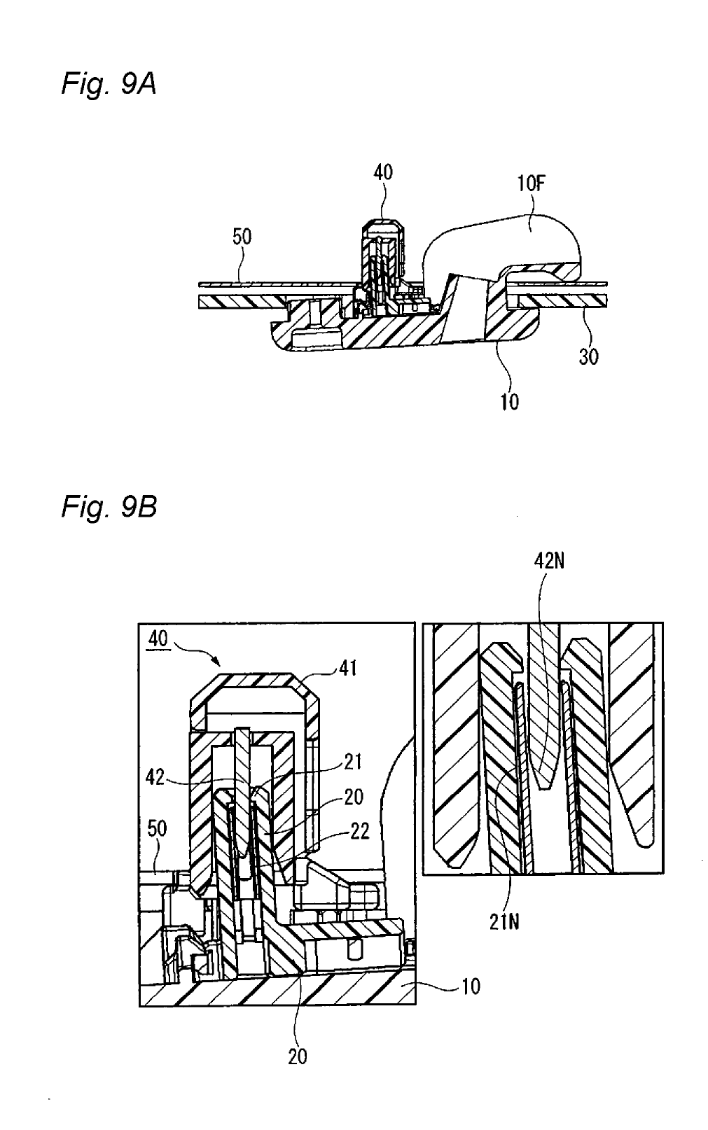

Both sides of a distal end portion of each of the male terminals 42 which face the wall surface 41F and the wall surface 41N of the male terminal 40 are cut away so that each male terminal 42 is formed into a pointed terminal as shown in FIG. 5B. By adopting this configuration, when the bracket 10 which installs the female connector 20 is rotated about the distal end of the bracket hook portion 12 as a fulcrum, as shown in FIG. 9B, the male terminal 42 is prevented from interfering with the female terminal 22, and hence, the terminals are not damaged by each other. Moreover, the male terminal 42 can be inserted into the female terminal 22 or the female terminal 22 can be fitted on the male terminal 42 with a low inserting force.

Returning to FIG. 1 again, the roof panel 50 is sheet metal which is positioned on the rear side of the ceiling 30 which defines the passenger compartment of the vehicle. Specifically, the roof panel 50 is a substantially rectangular flat plate material which is used to mount the bracket 10 on the ceiling 30. The substantially T-shaped opening 51 is formed in the central portion of the roof panel 50. The substantially T-shaped opening 51 is an opening which is formed by connecting a rectangular large opening portion 52 through which an upper portion of the male connector 40 and part of the bracket 10 are passed and a substantially square opening portion 53 through which the bracket hook portion 12 of the bracket 10 is passed.

In addition, a machine screw hole 54 is opened near the large opening portion 52 in the roof panel 50. This is a hole into which a distal end of a machine screw is screwed when the bracket 10 is fixed to the roof panel 50 with the machine screw with the ceiling 30 held therebetween.

Next, referring to FIGS. 7A to 10B, a mounting procedure of the bracket 10 according to the invention will be described.

As a first step, in advance, the male connector 40 is mounted on the ceiling 30 so as to be erected therefrom with the holding portions 41A which are formed at the lower end of the male connector 40 (FIG. 1) placed on the rear side of the ceiling 30 at the lateral surfaces 31A of the expanded opening portion of the opening portion 31 (FIG. 1). The roof panel 50 is situated on the rear side of the ceiling 30. Additionally, the locking projections 21A of the female connector 20 are restrained by the locking projection fastening pieces 13A on the bracket base 11. In addition, the locking bar 21B of the female connector 20 is restrained by the locking bar restraint piece 13B on the bracket base 11. End portions of the bracket base 11 of the bracket 10 which installs the female connector 20 are brought into abutment with a passenger compartment side of the ceiling 30, and the distal end of the bracket hook portion 12 of the bracket 10 is passed through the opening portion 31 in the ceiling 30 and the T-shaped opening 51 in the roof panel 50. The distal end of the bracket hook portion 12 is placed on the rear side of the roof panel 50, and the bracket 10 is started to be rotated about the distal end of the bracket hook portion 12 as a fulcrum. As shown in FIG. 7B, the upper surface of the female connector 20 is prevented from coming into contact with the distal end of the wall surface 41N which is shorter in length halfway through the rotation of the bracket 10, whereby the fitting of the female connector 20 into the male connector 40 is progressed smoothly. Further, the distal end 21L on the side of the female connector 20 which faces the wall surface 41F is guided inwards smoothly by the guide surface 42L, whereby the fitting of the female connector 20 into the male connector 40 is also progressed smoothly.

As shown in FIGS. 8A and 8B, as a second step, when the bracket 10 is rotated further, the fitting of the female connector 20 into the male connector 40 is progressed without interference of the undercut 42M formed at the distal end of the male connector 40 with the halfway portion 21M of the female connector 20.

As a third step, when the bracket is rotated further, the female terminal 22 is placed on the male terminal 42 (FIG. 9B) or the male terminal 42 is inserted into the female terminal 22. In the related mounting structure, the male terminal 42 comes into strong interference with the inner side of the female terminal 22 at a certain point in time. However, according to the mounting structure of the invention, since both the sides of each of the male terminals 42 of the male connector 40 which faces the wall surface 41F and the wall surface 41N thereof are cut away so that the male terminal is formed into the pointed terminal, as shown in FIG. 9B, the fitting of the female connector 20 into the male connector 40 is progressed without interference of the male terminals 42 with the female terminals 22.

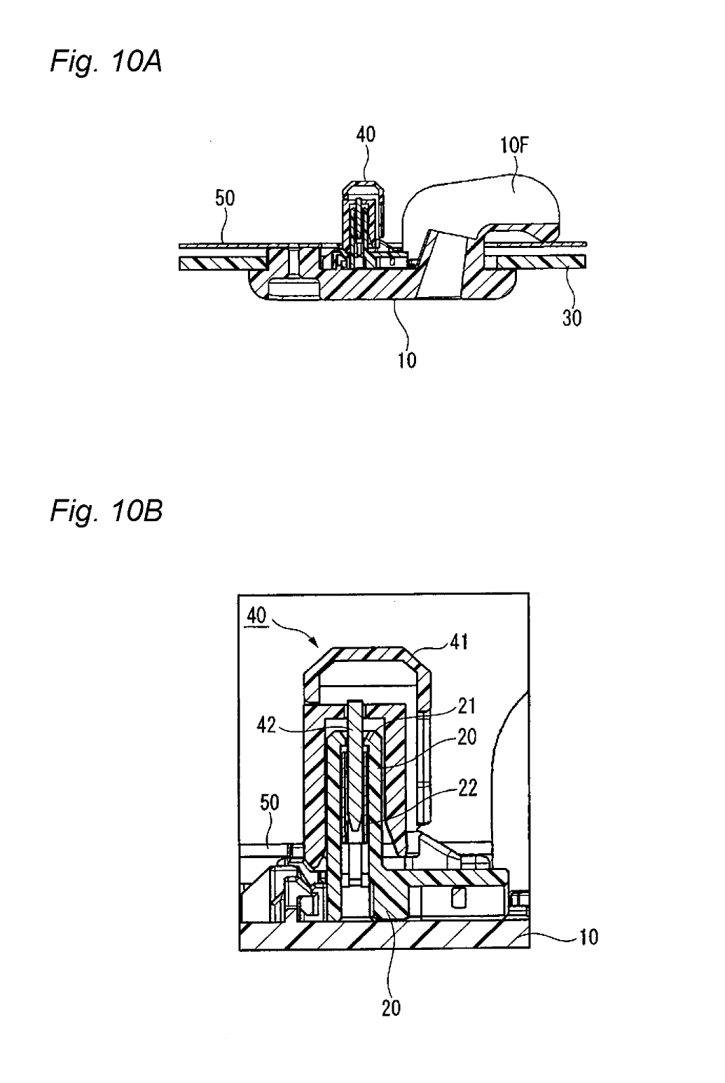

As shown in FIGS. 10A and 10B, as a fourth step, when the bracket 10 is rotated further, the bracket 10 is supported on the roof panel 50. In this state, the roof panel 50 is pressed against the ceiling 30 by the hook arm pieces 12F, and the ceiling 30 and the roof panel 50 are held by the one end of the bracket 10 and the hook arm pieces 12F, 12F therebetween.

Thus, the mounting procedure of the bracket 10 has been described heretofore. When the bracket 10 is removed from the ceiling 30, the mounting procedure that has been described above can be performed in an opposite order.

According to the invention, the following advantages are achieved when the bracket which installs the connector is rotated about the distal end portion of the bracket hook portion as the fulcrum.

The upper surface of the connector is prevented from coming into contact with the distal end of the wall surface, whereby the connector is allowed to fit into the mating connector in a smooth fashion. In addition, the connector can be made smaller in size, and the connector can be guided to the predetermined rigid position by the outer wall.

Since the distal end on the side of the connector which faces the wall surface of the mating connector is introduced inwards smoothly by the guide surface, the connector is fitted into the mating connector smoothly.

Since the halfway portion of the connector is prevented from coming into contact with the wall surface of the mating connector due to the undercut, the connector can be fitted into the mating connector with the low inserting force.

The terminals of the connectors are prevented from interfering with each other, where the terminals are not damaged by each other, and moreover, the terminals are inserted in one in the other or placed on one on the other with the low inserting force.

The above-mentioned embodiment is merely a typical example of the present invention, and the present invention is not limited to the embodiment. That is, the present invention can be variously modified and implemented without departing from the essential features of the present invention.

The present application is based on Japanese Patent Application No. 2011-101736 filed on Apr. 28, 2011, the contents of which are incorporated herein by way of reference.

### INDUSTRIAL APPLICABILITY

In accordance with a vehicle interior illumination lamp mounting structure of the invention, the mounting work of mounting a bracket on a roof panel via a ceiling is easily performed, a bending step that is involved in forming the roof panel is obviated, and a possibility that a temporarily locked connector is unlocked by external impact is eliminated.

### REFERENCE SIGNS LIST

10 bracket
11 bracket base
12 bracket hook portion
13B locking bar restraint piece
12F hook arm piece
12R distal ends connecting portion
13 female connector mounting portion
13A locking projection fastening piece
13B locking bar restraint piece
14 boss
14N screw hole
20 female connector (second connector)
20H female connector base portion
20K opening
20V vertical portion
21 connector housing
21A locking projection
21B locking bar
21F leg portion
22 female terminal
30 ceiling
31 opening portion
31A lateral surface
40 male connector (first connector)
41A holding portion
41B fixing portion
41C horizontal portion
41S perpendicularly downward extending portion
41N wall surface situated near rotating side (second wall)
41F wall surface situated far away from rotating side (first wall)
42L guide surface
42M undercut
50 roof panel

1. A vehicle interior illumination lamp mounting structure comprising:
a roof panel formed with an opening;
a first connector, configured to be mounted on a ceiling;
a bracket including a bracket hook portion configured to be locked on an edge of the opening; and
a second connector, locked on the bracket, and configured to be fitted to the first connector mounted on the ceiling by rotating the bracket,
wherein the first connector includes a first wall and a second wall which are configured to receive the second connector therebetween,
wherein the first wall is situated far away from the bracket hook portion than the second wall in a state where the bracket is locked on the opening, and
wherein a length of the first wall is longer than a length of the second wall in a rotating direction of the bracket.

2. The vehicle interior illumination lamp mounting structure according to claim 1,
wherein the first wall is formed with a guide surface configured to introduce a distal end of the second connector at a distal end of the first wall.

3. The vehicle interior illumination lamp mounting structure according to claim 2,
wherein the second wall is formed with an undercut surface configured to avoid an interference with the second connector at a distal end of the second wall.

4. The vehicle interior illumination lamp mounting structure according to claim 3,
wherein a first terminal is provided in the first connector between the first wall and the second wall, and
wherein the first terminal is formed with undercut surfaces on both sides of a distal end of the first terminal, so as to avoid an interference with a second terminal provided in the second connector.
